(19) United States
(12) Patent Application Publication
(10) Pub. No.: US 2017/0110219 A1
(43) Pub. Date: Apr. 20, 2017

(54) REINFORCING TAPE FOR FLAT CABLE AND FLAT CABLE

(71) Applicant: SUMITOMO ELECTRIC INDUSTRIES, LTD., Osaka-shi, Osaka (JP)

(72) Inventors: Shigeyuki TANAKA, Osaka (JP); Yutaka FUKUDA, Osaka (JP); Shinya NISHIKAWA, Osaka (JP)

(21) Appl. No.: 15/127,799

(22) PCT Filed: Apr. 14, 2015
(86) PCT No.: PCT/JP2015/061410

§ 371 Date: Sep. 21, 2016

(30) Foreign Application Priority Data
Apr. 28, 2014 (JP) 2014-093141

(51) Int. Cl. H01B 7/08; C09J 167/02; C09J 11/06; C09J 7/02; B32B 15/09; B32B 7/12

(52) U.S. Cl. CPC H01B 7/08; B32B 15/09; B32B 7/12; C09J 11/06; C09J 7/02; C09J 167/02; B32B 2307/202; B32B 2457/00; B32B 2405/00

(57) ABSTRACT

Provided are reinforcing tape for a flat cable, which can maintain sufficient adhesive force for a long time in a high-temperature, high-humidity environment, and a flat cable that uses this reinforcing tape for a flat cable. The present invention provides a reinforcing tape for a flat cable, the reinforcing tape including a base layer containing a resin as a main component, and an adhesive layer stacked on one side of the base layer, in which the adhesive layer contains a thermoplastic resin and a polycarbodiimide compound, and the polycarbodiimide compound contains an isocyanate group. The content of the polycarbodiimide compound relative to 100 parts by mass of the thermoplastic resin is preferably 0.5 parts by mass or more and 10 parts by mass or less. The polycarbodiimide compound preferably further contains an alicyclic structure.

### TECHNICAL FIELD

The present invention relates to a reinforcing tape for a flat cable, and a flat cable.

### BACKGROUND ART

Flat cables are used as electric wires for internal wiring of electronic appliances. A flat cables is produced by sandwiching plural conductors arranged side-by-side between two coating materials and integrating the conductors and the coating materials by heating or the like.

A flat cable has a region at one end in the longitudinal direction, where the conductors are exposed so as to be connectable to a connector or the like. This exposed region has a lower strength than other regions and cannot be easily connected to a connector or the like as is; accordingly, the practice has been to reinforce the strength of this exposed region by bonding a reinforcing tape on one side of the exposed region (refer to Japanese Unexamined Patent Application Publication Nos. 6-275137 and 2008-218252).

### CITATION LIST

### Patent Literature

PTL 1 Japanese Unexamined Patent Application Publication No. 6-275137
PTL 2 Japanese Unexamined Patent Application Publication No. 2008-218252

### SUMMARY OF INVENTION

### Technical Problem

However, in recent years, flat cables have been increasingly used in a wide variety of environments such as a high-temperature environment and a high-humidity environment. Under such trends, the reinforcing tape has been required to maintain high adhesion for a long time in a variety of environments; however, the reinforcing tape of the related art described above does not sufficiently maintain adhesive force.

The present invention has been made under the above-described circumstances and an object thereof is to provide a reinforcing tape for a flat cable, which can maintain sufficient adhesive force for a long time in a high-temperature, high-humidity environment, and a flat cable that uses this reinforcing tape for a flat cable.

### Solution to Problem

The invention made to achieve the object described above provides a reinforcing tape for a flat cable. The reinforcing tape includes a base layer containing a resin as a main component, and an adhesive layer stacked on one side of the base layer, in which the adhesive layer contains a thermoplastic resin and a polycarbodiimide compound, and the polycarbodiimide compound contains an isocyanate group.

Another invention which has been made to achieve the object described above provides a flat cable that includes at least one conductor and a pair of coating materials sandwiching the at least one conductor, in which the flat cable has a region where the at least one conductor is exposed, the region being located in an end portion in a longitudinal direction, and the flat cable further includes the reinforcing tape for a flat cable described above, the reinforcing tape being stacked so that the adhesive layer is bonded to one side of the exposed region.

### Advantageous Effects of Invention

According to the present invention, a reinforcing tape which can maintain sufficient adhesive force for a long time in a high-temperature, high-humidity environment, and a flat cable are provided.

### BRIEF DESCRIPTION OF DRAWINGS

FIG. 1 is a schematic cross-sectional view of a reinforcing tape for a flat cable according to an embodiment of the present invention.

FIG. 2 is a schematic plan view of a flat cable according to an embodiment of the present invention.

FIG. 3 is a schematic cross-sectional view taken along line X1-X1 in FIG. 2.

### DESCRIPTION OF EMBODIMENTS

### Description of Embodiments of the Present Invention

The present invention provides a reinforcing tape for a flat cable, the reinforcing tape including a base layer containing a resin as a main component, and an adhesive layer stacked on one side of the base layer, in which the adhesive layer contains a thermoplastic resin and a polycarbodiimide compound, and the polycarbodiimide compound contains an isocyanate group.

According to this reinforcing tape for a flat cable, it is believed that the isocyanate group contained in the polycarbodiimide compound causes crosslinking between polycarbodiimide compound molecules and/or between the polycarbodiimide compound and the thermoplastic resin in the presence of water, and improves heat resistance of the adhesive layer. It is also believed that since the carbodiimide group of the carbodiimide compound reacts with moisture in air, hydrolysis of the thermoplastic resin is suppressed. As a result, the reinforcing tape for a flat cable can maintain adhesive force for a long time in a high-temperature, high-humidity environment.

The polycarbodiimide compound content relative to 100 parts by mass of the thermoplastic resin is preferably 0.5 parts by mass or more and 10 parts by mass or less. When the polycarbodiimide compound content is within this range, the heat resistance and the hydrolysis suppressing effect are further improved.

The polycarbodiimide compound preferably further contains an alicyclic structure. When the polycarbodiimide compound further contains an alicyclic structure, the polycarbodiimide compound and the like undergo steric hindrance. As a result, heat resistance of the adhesive layer is further improved.

The thermoplastic resin is preferably a thermoplastic polyester. When the thermoplastic resin is a thermoplastic polyester, mechanical strength of the adhesive layer is improved. Furthermore, the adhesive layer can be easily worked and can be manufactured at a low cost.

The main component of the base layer is preferably polyethylene terephthalate. When the main component of the base layer is polyethylene terephthalate, the manufacturing cost can be reduced while increasing the strength of the base layer.

The present invention also provides a flat cable that includes at least one conductor and a pair of coating materials that sandwich the at least one conductor, in which the flat cable has, at an end in a longitudinal direction, a region where the at least one conductor is exposed, and further includes the above-described reinforcing tape for a flat cable, the reinforcing tape being stacked on one side of the exposed region so that the adhesive layer is bonded to the exposed region.

According to this flat cable, since the reinforcing tape is provided in the region where the conductor is exposed, the reinforcing tape stays stably bonded to the exposed region for a long time in a high-temperature, high-humidity environment.

As a result, the flat cable exhibits high stability in a high-temperature, high-humidity environment.

The outermost layer of each coating material preferably contains a polyphenylene sulfide as a main component. When the main component of the outermost layer of the coating material is polyphenylene sulfide, the coating material exhibits improved heat resistance and becomes more suitable for a high-temperature environment and the like. Since the outermost layer of the coating material is in contact with the adhesive layer, the isocyanate group and carbodiimide group contained in the polycarbodiimide compound interact with sulfur atoms in polyphenylene sulfide so as to improve adhesive force between the coating material and the adhesive layer.

The “main component” here means the component that has the highest content (for example, a component having a content of 50% by mass or more).

### Details of the Embodiments of the Present Invention

The reinforcing tape for a flat cable, and the flat cable according to the present invention will now be described with reference to the drawings. The present invention is not limited by these illustrative examples but only by the claims, and is intended to include all modifications and alterations within the scope of the claims and their equivalents.

### [Reinforcing Tape for a Flat Cable]

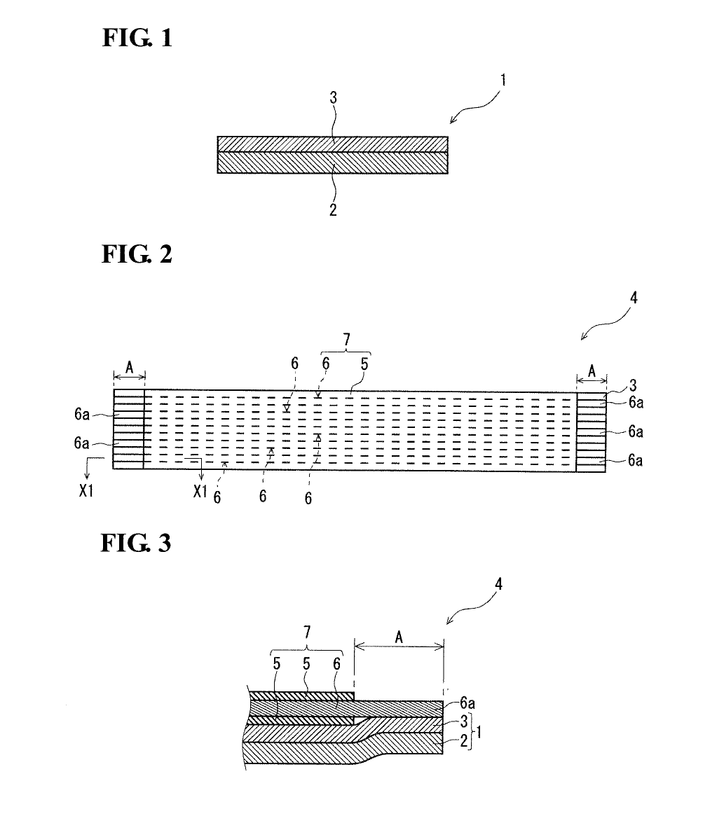

FIG. 1 is a schematic cross-sectional view of a reinforcing tape for a flat cable according to one embodiment of the present invention.

A reinforcing tape 1 for a flat cable shown in FIG. 1 includes a base layer 2 and an adhesive layer 3 stacked on one side of the base layer 2. The reinforcing tape 1 is, for example, bonded to an end portion 6a of a conductor 6 in an exposed region A of a flat cable 4 (FIGS. 2 and 3) described below.

### <Base Layer>

The base layer 2 contains a resin as a main component. The base layer 2 may contain other components in addition to the resin as long as the effects of the present invention are not adversely affected.

The resin may be any resin that has mechanical strength that can reinforce the exposed region. The resin preferably has an electrical insulating property. Examples of the resin include polyester resins such as polyethylene terephthalate, polybutylene terephthalate, and polyethylene naphthalate;

polyamide resins such as nylon 6, nylon 66, and nylon 610, and polyolefin resins such as polyethylene and polypropylene;

acrylic resins such as polycarbonate, polystyrene, polyacrylate, polymethacrylate, and polymethyl methacrylate;

polyimide resins such as polyimide, polyamide-imide, and polyester imide; and

polyarylate, polyether sulfone, polyphenylene sulfide, polyether-ether ketone, and polyether sulfide.

The resin is preferably a polyester resin and more preferably polyethylene terephthalate from the viewpoints of mechanical strength, processing ease, and cost.

The length and the width of the base layer 2 may be appropriately set according to usage and the like. The upper limit of the average thickness of the base layer 2 is preferably 300 μm, more preferably 250 μm, and yet more preferably 200 μm. The lower limit of the average thickness of the base layer 2 is preferably 20 μm, more preferably 30 μm, and yet more preferably 50 μm. When the average thickness exceeds the upper limit, the thickness of the end portions of the flat cable or the like increases unnecessarily, and connection to a connector or the like may become difficult to establish. In contrast, when the average thickness is less than the lower limit, the strength of the exposed region of the flat cable or the like is insufficient, and the exposed region may easily break.

The base layer 2 may be surface-treated to enhance adhesion to the adhesive layer 3. An example of the surface treatment is a corona treatment. By conducting the corona treatment, polar functional groups such as hydroxyl groups and carbonyl groups are introduced into the surface of the resin film 2, and hydrophilicity is imparted. The surface treatment may be conducted by other methods, such as a chemical treatment.

A primer layer (adhesion-imparting layer) may be further stacked on a surface of the base layer 2 onto which the adhesive layer 3 is to be stacked. When the primer layer is provided on the surface of the base layer 2 onto which the adhesive layer 3 is to be stacked, adhesion between the base layer 2 and the adhesive layer 3 improves as in the case of performing the surface treatment. The same resins as those described as examples of the resins for the base layer 2, or urethane resins can be used to form the primer layer, for example.

In addition, a coloring layer may be further stacked on a surface of the base layer 2. The coloring layer may be stacked on either surface of the base layer 2. When the coloring layer is further stacked on a surface of the base layer 2, design of the reinforcing tape 1 is improved. The coloring layer may be formed by using a mixture of a pigment, a dye, or the like, and any of the resins described as the examples for the base layer 2 above, or a urethane resin.

The upper limit of the average thicknesses of the primer layer and the coloring layer is preferably 50 μm and more preferably 30 μm. The lower limit of the average thicknesses is preferably 0.5 μm and more preferably 1 μm. When the average thicknesses exceed the upper limit, the thickness of end portions of the flat cable or the like increases unnecessarily, and a connection to a connector or the like may become difficult to establish. Conversely, when the average thicknesses are lower than the lower limit, adhesion may not be sufficiently improved and the coloring layer may easily break.

### <Adhesive Layer>

The adhesive layer 3 is a layer stacked on one side of the base layer 2. The reinforcing tape is bonded to an exposed region of a flat cable or the like due to this adhesive layer 3.

The adhesive layer 3 contains a thermoplastic resin and a polycarbodiimide compound. The adhesive layer 3 may further contain other components as long as the effects of the present invention are not adversely affected.

### (Thermoplastic Resin)

The thermoplastic resin may be any adhesive thermoplastic resin that can be mixed with a polycarbodiimide compound. Examples of the thermoplastic resin are the same as those described above for the base layer 2. Among these, thermoplastic polyesters are preferable, and thermoplastic polyester elastomers and polyethylene terephthalate are more preferable. The adhesive layer 3 preferably contains these resins as a main component.

### (Polycarbodiimide Compound)

The polycarbodiimide compound contains an isocyanate group and a carbodiimide group. An example of the polycarbodiimide compound is a compound in which a hydrogen atom of a polycarbodiimide is substituted with an isocyanate group.

Examples of the polycarbodiimide include a polycarbodiimide that contains only a linear hydrocarbon group and an isocyanate group, and a polycarbodiimide that further contains an alicyclic structure or an aromatic ring structure in addition to these groups.

Examples of the polycarbodiimide that contains only a linear hydrocarbon group and an isocyanate group include poly(1,6-hexamethylenecarbodiimide) and poly(diisopropylcarbodiimide).

Examples of the polycarbodiimide further containing an alicyclic structure include poly(4,4′-methylenebiscyclohexylcarbodiimide), poly(1,3-cyclohexylenecarbodiimide), poly(1,4-cyclohexylenecarbodiimide), and poly(4,4′-dicyclohexylmethanecarbodiimide).

Examples of the polycarbodiimide further containing an aromatic ring structure include poly(4,4′-diphenylmethanecarbodiimide), poly(3,3′-dimethyl-4,4′-diphenylmethanecarbodiimide), poly(naphthylenecarbodiimide), poly(p-phenylenecarbodiimide), poly(m-phenylenecarbodiimide), poly(tolylcarbodiimide), poly(methyl-diisopropylphenylenecarbodiimide), poly(1,3,5-triisopropylbenzene)polycarbodiimide, poly(triethylphenylenecarbodiimide), and poly(triisopropylphenylenecarbodiimide).

The polycarbodiimide compound preferably contains an alicyclic structure and more preferably contains a cyclohexyl group from the viewpoint of achieving both workability and heat resistance.

The upper limit of the isocyanate group content in the polycarbodiimide compound is preferably 5% by mass and more preferably 3% by mass. The lower limit of the content is preferably 0.5% by mass and more preferably 1% by mass. When the content exceeds the upper limit described above, crosslinking reaction and the like occur excessively, and the workability of the adhesive layer 3 may be degraded. Conversely, when the content is less than the lower limit, adhesive force of the adhesive layer 3 at high temperature and high humidity may not be sufficiently maintained.

The upper limit of the polycarbodiimide compound content in the adhesive layer 3 relative to 100 parts by mass of the thermoplastic resin is preferably 10 parts by mass, more preferably 8 parts by mass, and yet more preferably 7 parts by mass. The lower limit of the polycarbodiimide compound content relative to 100 parts by mass of the thermoplastic resin is preferably 0.5 parts by mass, more preferably 1 part by mass, and yet more preferably 2 parts by mass.

### (Other Components)

Examples of other components that may be contained in the adhesive layer 3 include resins other than thermoplastic resins, a flame retardant, a flame retarding aid, a pigment, an antioxidant, a masking agent, a lubricant, a process stabilizer, a plasticizer, and a foaming agent.

The flame retardant imparts flame retardancy to the adhesive layer 3. Examples of the flame retardant include halogen-based flame retardants such as chlorine-based flame retardants and bromine-based flame retardants.

The flame retarding aid further improves flame retardancy of the adhesive layer 3. An example of the flame retarding aid is antimony trioxide.

The pigment gives a color to the adhesive layer 3. Various known pigments can be used as the pigment. For example, titanium oxide can be used.

The antioxidant prevents oxidation of the adhesive layer 3. Various known antioxidants can be used. For example, a phenol-based antioxidant can be used.

The upper limit of the average thickness of the adhesive layer 3 is preferably 100 μm and more preferably 80 μm. The lower limit of the average thickness of the adhesive layer 3 is preferably 10 μm and more preferably 30 μm. When the average thickness of the adhesive layer 3 exceeds the upper limit, adhesion to conductors or the like may be degraded. Conversely, when the average thickness of the adhesive layer 3 is less than the lower limit, adhesion of the adhesive layer 3 itself may not be sufficiently obtained.

### <Method for Making Reinforcing Tape>

Examples of the method for making the reinforcing tape 1 include a method that involves extrusion-forming a base layer 2 and an adhesive layer 3 separately into films, stacking the films, and laminating the stacked films by heat, a method that involves forming the base layer 2 and the adhesive layer 3 by co-extrusion, and a method that involves directly forming the adhesive layer 3 on the base layer 2 by extrusion.

In the lamination method described above, the upper limit of the lamination temperature is preferably 130° C. and more preferably 110° C. The lower limit of the lamination temperature is preferably 60° C. and more preferably 70° C. When the lamination temperature exceeds the upper limit, the base layer 2 and the adhesive layer 3 may thermally deform. Conversely, when the lamination temperature is lower than the lower limit, the base layer 2 may not sufficiently bond to the adhesive layer 3.

The upper limit of the lamination speed is preferably 50 m/min and more preferably 40 m/min. The lower limit of the lamination speed is preferably 5 m/min and more preferably 10 m/min. When the lamination speed exceeds the upper limit, the base layer 2 may not sufficiently bond to the adhesive layer 3. Conversely, when the lamination speed is less than the lower limit, productivity of the reinforcing tape 1 may be degraded.

### <Advantages>

The reinforcing tape 1 includes a base layer 2 and an adhesive layer 3, and the adhesive layer 3 contains a polycarbodiimide compound. The polycarbodiimide compound contains an isocyanate group and a carbodiimide group. The isocyanate group and the carbodiimide group can each react with water and bond to the thermoplastic resin or the like in the adhesive layer 3. Accordingly, deterioration of the adhesive layer 3 caused by moisture in air is decreased, and heat resistance of the adhesive layer 3 is improved. As a result, the reinforcing tape 1 can maintain adhesive force for a long time in a high-temperature, high-humidity environment.

### [Flat Cable]

A flat cable 4 shown in FIGS. 2 and 3 includes plural conductors 6 and a pair of coating materials 5 that sandwich the conductors 6. In the flat cable, exposed regions A in which the conductors 6 are exposed are provided in two end portions in the longitudinal direction. The flat cable 4 further includes a reinforcing tape 1 stacked on one side of each exposed region A so that the adhesive layer 3 is bonded to the exposed region A. In FIGS. 2 and 3, parts and the like that are similar to those of the reinforcing tape 1 shown in FIG. 1 are denoted by the same reference symbols, and the description therefor is omitted to avoid redundancy.

### <Coating Material>

The coating material 5 serves as a protective film of the flat cable 4. The coating material 5 is used to improve wear resistance, voltage resistance, etc. The coating material 5 may be a single layer or a multilayer. The coating material 5 may contain other components such as a flame retardant.

Examples of the main component of the coating material 5 include the same resins as those described as examples for the base layer 2. Among these, polyphenylene sulfide is preferable for its excellent heat resistance. In particular, the outermost layer to be bonded to the reinforcing tape 1 preferably contains polyphenylene sulfide as a main component.

The length and width of the coating material 5 may be appropriately set according to usage and the like. The lower limit of the average thickness of the coating material 5 is preferably 6 μm, more preferably 9 μm, and yet more preferably 12 μm. When the average thickness is less than the lower limit, sufficient rigidity may not be obtained. The upper limit of the average thickness of the coating material 5 is preferably 75 μm, more preferably 50 μm, and yet more preferably 40 μm. When the average thickness is larger than the upper limit, sufficient flexibility may not be obtained.

### <Conductor>

The conductors 6 are sandwiched between a pair of coating materials 5, and are arranged to extend throughout the entire length of the flat cable 4 in the longitudinal direction. End portions 6a of the conductors 6 that exist in the exposed regions A are not covered by the coating materials 5 and remain exposed. The end portions 6a are portions through which the conductors 6 of the flat cable 4 connect to connecting terminals of a printed substrate, an electronic component, and the like.

The conductors 6 are formed of a conductive metal such as copper, tin-plated annealed copper, or nickel-plated annealed copper. The conductors 6 are preferably foils composed of a conductive metal. The average thickness of the conductors 6 may be determined according to the magnitude of the current used and the like. For example, when the conductors 6 are foils, the average thickness is 20 μm or more and 100 μm or less.

The lower limit of the peel strength of the adhesive layer 3 to the coating material 5 immediately after bonding is preferably 15 N/10 mm, more preferably 25 N/10 mm, yet more preferably 40 N/10 mm, and most preferably 45 N/10 mm. Here, the peel strength is a value measured according to JIS-K-6854-2 (1999), “Adhesives—Determination of peel strength of bonded assemblies—Part 2: 180° peel.”

The lower limit of the peel strength of the adhesive layer 3 to the coating material 5 120 hours after bonding in an environment at a temperature of 85° C. and a humidity of 85% is preferably 7 N/10 mm, more preferably 20 N/10 mm, yet more preferably 40 N/10 mm, and most preferably 45 N/10 mm.

The lower limit of the peel strength of the adhesive layer 3 to the coating material 5 240 hours after bonding in an environment at a temperature of 85° C. and a humidity of 85% is preferably 5 N/10 mm, more preferably 20 N/10 mm, yet more preferably 40 N/10 mm, and most preferably 45 N/10 mm.

The lower limit of the peel strength of the adhesive layer 3 to the coating material 5 500 hours after bonding in an environment at a temperature of 85° C. and a humidity of 85% is preferably 5 N/10 mm, more preferably 15 N/10 mm, yet more preferably 40 N/10 mm, and most preferably 45 N/10 mm.

The lower limit of the peel strength of the adhesive layer 3 to the coating material 5 1,000 hours after bonding in an environment at a temperature of 85° C. and a humidity of 85% is preferably 5 N/10 mm, more preferably 15 N/10 mm, yet more preferably 30 N/10 mm, and most preferably 40 N/10 mm.

When the peel strength of the adhesive layer 3 to the coating material 5 is less than the lower limit, the reinforcing tape 1 may not sufficiently bond to a cable body 7, and may lack stability in a high-temperature, high-humidity environment.

### <Method for Making Flat Cable>

A method for making a flat cable 5 includes, for example, a step of forming a cable body 7 by stacking a coating material 5, conductors 6, and another coating material 5 in this order and integrating them by applying heat and pressure (hereinafter this step may be referred to as a “cable body forming step”), and a step of bonding an reinforcing tape 1 to each of two end portions of the cable body 7 (hereinafter this step may be referred to as a “reinforcing tape bonding step”).

### [Cable Body Forming Step]

In the cable body forming step, first, the conductors 6 are sandwiched between a pair of coating materials 5. Specifically, conductors 6 are stacked on a surface of a coating material 5, and another coating material 5 is stacked on the surface of the conductors 6. This pair of coating materials 5 have a length in the longitudinal direction shorter than that of the conductors 6, as shown in FIGS. 2 and 3, and the conductors 6 are left exposed in the two end portions. Subsequently, the conductors 6 sandwiched between the pair of coating materials 5 are heated with a heat laminator or the like from above and under so as to bond the pair of coating materials 5 to the conductors 6 and to thereby form a cable body 7.

### [Reinforcing Tape Bonding Step]

In the reinforcing tape bonding step, the reinforcing tape 1 is bonded to each of two ends of the cable body 7. Specifically, the reinforcing tape 1 is placed on the back side (lower side in FIG. 3) of the cable body 7 so as to be in contact with both the conductors 6 and the coating material 5, and then heat is applied by using a heater or the like from the reinforcing tape side so as to bond the reinforcing tape 1 to the cable body 7. A known heater may be used as this heater.

The upper limit of the heating temperature is preferably 250° C. and more preferably 220° C. The lower limit of the heating temperature is preferably 100° C. and more preferably 120° C. When the heating temperature is higher than the upper limit, the reinforcing tape 1, the cable body 7, and the like may thermally deform. In contrast, when the heating temperature is lower than the lower limit, the reinforcing tape 1 may not sufficiently bond to the cable body 7, and the reinforcing tape 1 may easily separate.

The upper limit of the heating time is preferably 10 seconds and more preferably 7 seconds. The lower limit of the heating time is preferably 1 second and more preferably 2 seconds. When the heating time exceeds the upper limit, the reinforcing tape 1 and the cable body 7 may thermally deform, for example. In contrast, when the heating time is shorter the lower limit, the reinforcing tape 1 may not sufficiently bond to the cable body 7, and the reinforcing tape 1 may easily separate.

The upper limit of the pressure during the heating is preferably 0.8 MPa and more preferably 0.6 MPa. The lower limit of the pressure during the heating is preferably 0.01 MPa and more preferably 0.05 MPa. When the pressure during the heating exceeds the upper limit, the conductors 6 in the cable body 7 may break. In contrast, when the pressure during the heating is less than the lower limit, the reinforcing tape 1 may not sufficiently bond to the cable body 7, and the reinforcing tape 1 may easily separate from the cable body 7.

### <Advantages>

According to the flat cable 4, an exposed region A where the conductors 6 are exposed is provided at each end portion in the longitudinal direction and the reinforcing tape 1 is bonded to one side of the exposed region. Since the reinforcing tape 1 is bonded as such, the end portions 6a of the conductors 6 are protected, and the strength of the exposed region A is improved. Since the reinforcing tape 1 can maintain sufficient adhesive force for a long time even in a high-temperature, high-humidity environment, the flat cable 4 is suitable for use in automobiles, etc.

### Other Embodiments

The embodiments disclosed herein are merely illustrative in all respects and should not be construed as limiting. The scope of the present invention is not limited by the structures of the embodiments described above but is defined by the scope of the claims, and is intended to include all modifications and alterations within the scope of the claims and their equivalents.

In the embodiments described above, a flat cable including single-layer coating materials is described as an example; however, the coating material may be a multilayer. When the coating material is a multilayer, the layers therein may have the same composition or different compositions. However, the innermost layer that comes into contact with the conductors is preferably a coating adhesive layer. This coating adhesive layer plays a role of bonding the multilayer coating material to the conductors. Examples of the material for the coating adhesive layer include those thermoplastic resins given as examples for the adhesive layer described above.

When the coating material is a multilayer, the multilayer coating material is preferably integrated by lamination prior to stacking the conductors on the coating material. As a result, misplacement during stacking and the like can be reduced. The same procedure and conditions as the lamination for bonding the base layer and the adhesive layer can be applied to this lamination.

In the embodiments described above, a method for making a flat cable, involving stacking conductors on a coating material and stacking another coating material on the conductors has been described as an example. Alternatively, coating materials may be co-extruded to sandwich the conductors so as to carry out formation of the coating materials and bonding of the conductors simultaneously. Instead of the above-described method of bonding the coating materials and the conductors by heating, an adhesive may be applied to surfaces of the coating materials and conductors and the coating materials and the conductors may be press-bonded. Yet alternatively, a copper foil or the like may be bonded onto a surface of a coating material, and conductors may be formed on the coating material by etching the copper foil or the like. Alternatively, one surface of the coating material may be masked and then plating may be conducted to form conductors on the coating material.

The method for making a flat cable may further include a step of cutting the cable body to a desired length after forming the cable body. In this case, a region where conductors are exposed may be provided in a region other than the two end portions of the cable body, and the cable body may be cut within this exposed region. Alternatively, a region where the conductors are coated with coating materials may be cut, and then the coating materials near the cut portion may be removed. Known methods may be employed to cut the cable body and remove the coating materials.

### EXAMPLES

The present invention will now be described more specifically through Examples which do not limit the present invention.

### [Preparation of Resin Composition for Adhesive Layer]

### Synthetic Example 1 (Preparation of Resin Composition A1)

To 100 parts by mass of a thermoplastic polyester elastomer (VYLON GM400: Toyobo Co., Ltd.) serving as a thermoplastic resin, 0.5 parts by mass of CARBODILITE LA1 (Nisshinbo Chemical Inc.) serving as a polycarbodiimide compound having an isocyanate group was added, and the resulting mixture was mixed to homogeneity with a twin screw mixer so as to prepare a resin composition A1.

### Synthetic Examples 2 to 7 (Preparation of Resin Compositions A2, A3, and CA1 to 4)

Resin compositions A2, A3, and CA1 to CA4 were prepared as with the resin composition A1 except that polycarbodiimide compounds of the types and in amounts shown in Table 1 were used. In the table, Stabaxol P (Rhein Chemie Corporation) is a polycarbodiimide compound having no isocyanate group. The resin composition CA4 does not contain a polycarbodiimide compound.

TABLE 1

| | | Polycarbodiimide compound | |
|---|---|---|---|
| | | | Amount |
| | | | added |
| | Resin | | Parts |
| | composition | Type | by mass |
| Synthetic Example 1 | A1 | CARBODILITE LA1 | 0.5 |
| Synthetic Example 2 | A2 | CARBODILITE LA1 | 1.0 |
| Synthetic Example 3 | A3 | CARBODILITE LA1 | 2.0 |
| Synthetic Example 4 | CA1 | Stabaxol P | 0.5 |
| Synthetic Example 5 | CA2 | Stabaxol P | 1.0 |
| Synthetic Example 6 | CA3 | Stabaxol P | 2.0 |
| Synthetic Example 7 | CA4 | — | — |

### Example 1

### <Preparation of Reinforcing Tape>

One side of a film 188 μm in average thickness formed of polyethylene terephthalate (Lumirror: Toray Industries Inc.) was subjected to a corona treatment to form a base layer. A film 0.1 mm in average thickness was formed by extrusion using the resin composition A1 as the material so as to form an adhesive layer. The adhesive layer was placed on the corona-treated surface of the base layer, and the base layer and the adhesive layer were bonded to each other by being heated from the base layer side and the adhesive layer side using heaters. As a result, a reinforcing tape was obtained. The heating conditions during this bonding were as follows: temperature at the base layer side and the adhesive layer side: 100° C., lamination speed 10 m/min.

### Examples 2 and 3, and Comparative Examples 1 to 4

Reinforcing tapes were made as in Example 1 above except that the resin compositions of the types shown in Table 2 were used to form adhesive layers.

### [Evaluation]

### <Preparation of Evaluation Samples>

The reinforcing tape was placed on a polyphenylene sulfide (PPS) (Torelina: Toray Industries Inc.) film 25 μm in thickness, and the reinforcing tape and the PPS film were bonded to each other by being heated from both the reinforcing tape side and the PPS film side using heaters. As a result, an evaluation sample was obtained. The heating and pressurizing conditions during the bonding were as follows: temperature at the reinforcing tape side and the PPS film side: 215° C., heating time: 5 seconds, pressure during heating: 0.4 MPa.

### <Adhesive Force>

The adhesive force was evaluated by placing the evaluation sample in an environment at a temperature of 85° C. and a humidity of 85%, and measuring the peel strength at three points immediately, 120 hours, 240 hours, 500 hours, and 1,000 hours after the bonding of the reinforcing tape.

The peel strength was measured according to JIS-K-6854-2 (1999) “Adhesives—Determination of peel strength of bonded assemblies—Part 2: 180° peel”. The measurement results and the average of three points are shown in Table 2.

TABLE 2

| | | | Immediately | | | | |
|---|---|---|---|---|---|---|---|
| | Resin | | after | 120 | 240 | 500 | 1,000 |
| | composition | | bonding | hours after | hours after | hours after | hours after |
| Example 1 | A1 | First time | 47.3 | 26.8 | 7.5 | 17.0 | 7.1 |
| | | Second time | 17.5 | 8.6 | 8.5 | 17.8 | 7.0 |
| | | Third time | 22.7 | 9.5 | 6.8 | 15.0 | 8.4 |
| | | Average | 29.0 | 15.0 | 7.6 | 16.6 | 7.5 |
| Example 2 | A2 | First time | 47.3 | 23.2 | 6.5 | 5.2 | 26.2 |
| | | Second time | 16.7 | 7.0 | 3.9 | 5.0 | 5.4 |
| | | Third time | 22.2 | 7.8 | 6.4 | 4.1 | 30.2 |
| | | Average | 29.0 | 13.0 | 5.6 | 4.8 | 20.6 |
| Example 3 | A3 | First time | 56.2 | 51.7 | 50.6 | 57.0 | 46.5 |
| | | Second time | 54.1 | 54.7 | 51.7 | 53.0 | 58.2 |
| | | Third time | 57.5 | 51.8 | 48.4 | 53.0 | 49.0 |
| | | Average | 56.0 | 53.0 | 50.0 | 54.3 | 51.2 |
| Comparative | CA1 | First time | 22.7 | 14.7 | 5.8 | 10.0 | 5.1 |
| Example 1 | | Second time | 22.7 | 7.1 | 7.1 | 5.8 | 5.2 |
| | | Third time | 23.5 | 15.3 | 6.8 | 11.7 | 5.1 |
| | | Average | 23.0 | 12.0 | 6.5 | 9.2 | 5.1 |
| Comparative | CA2 | First time | 13.3 | 23.5 | 6.4 | 28.5 | 19.0 |
| Example 2 | | Second time | 23.7 | 30.5 | 6.6 | 26.0 | 17.8 |
| | | Third time | 19.7 | 7.2 | 5.9 | 5.9 | 20.0 |
| | | Average | 19.0 | 20.0 | 6.3 | 20.1 | 18.9 |
| Comparative | CA3 | First time | 20.7 | 19.3 | 8.6 | 17.1 | 5.6 |
| Example 3 | | Second time | 22.3 | 6.5 | 20.6 | 13.8 | 35.0 |
| | | Third time | 19.3 | 22.0 | 17.9 | 6.1 | 4.2 |
| | | Average | 21.0 | 16.0 | 16.0 | 12.3 | 14.9 |
| Comparative | CA4 | First time | 10.8 | 2.1 | 13.2 | 5.5 | 2.3 |
| Example 4 | | Second time | 19.5 | 13.1 | 6.8 | 6.8 | 2.2 |
| | | Third time | 19.3 | 4.6 | 6.2 | 8.5 | 1.5 |
| | | Average | 17.0 | 6.6 | 8.7 | 6.9 | 2.0 |

The portions where peeling occurred in the test are indicated in Table 3. In Table 3, “A” indicates samples in which peeling did not occur between the base layer and the adhesive layer and between the PPS film and the adhesive layer, and peeling occurred due to breaking of the PPS film. “B1” indicates samples in which peeling did not occur between the adhesive layer and the base layer but between the adhesive layer and the PPS film. “B2” indicates samples in which peeling did not occur between the PPS film and the adhesive layer but between the adhesive layer and the base layer.

TABLE 3

| | | | Immediately | | | | |
|---|---|---|---|---|---|---|---|
| | Resin | | after | 120 | 240 | 500 | 1,000 |
| | composition | | bonding | hours after | hours after | hours after | hours after |
| Example 1 | A1 | First time | B1 | B1 | B2 | B1 | B1 |
| | | Second time | B2 | B2 | B2 | B1 | B1 |
| | | Third time | B2 | B2 | B2 | B1 | B1 |
| Example 2 | A2 | First time | B1 | B1 | B2 | B2 | B1 |
| | | Second time | B2 | B2 | B2 | B2 | B2 |
| | | Third time | B2 | B2 | B2 | B2 | B1 |
| Example 3 | A3 | First time | B1 | B1 | A | A | B1 |
| | | Second time | B1 | A | A | A | A |
| | | Third time | B1 | A | A | A | A |
| Comparative | CA1 | First time | B2 | B1 | B2 | B1 | B1 |
| Example 1 | | Second time | B2 | B2 | B2 | B2 | B1 |
| | | Third time | B2 | B2 | B2 | B1 | B1 |
| Comparative | CA2 | First time | B2 | B1 | B2 | B1 | B1 |
| Example 2 | | Second time | B2 | B2 | B2 | B1 | B1 |
| | | Third time | B2 | B2 | B2 | B2 | B2 |
| Comparative | CA3 | First time | B2 | B2 | B2 | B2 | B2 |
| Example 3 | | Second time | B2 | B2 | B2 | B2 | B1 |
| | | Third time | B2 | B2 | B2 | B2 | B2 |
| Comparative | CA4 | First time | B2 | B2 | B1 | B2 | B1 |
| Example 4 | | Second time | B2 | B2 | B2 | B1 | B1 |
| | | Third time | B2 | B2 | B2 | B1 | B1 |

As shown in Table 2, the reinforcing tapes of Examples 1 to 3 exhibited a tendency of showing high adhesive force immediately after bonding, and high adhesive force 1,000 hours after bonding. In particular, the reinforcing tape of Example 3 has excellent adhesive force. In contrast, reinforcing tapes of Comparative Examples exhibited a tendency of showing lower adhesive force immediately after bonding and 1,000 hours after bonding.

As shown in Table 3, in particular, the reinforcing tape of Example 3 exhibits high adhesive force to both the base layer and the PPS film even after an elapse of a long time.

### Synthetic Examples 8 to 12 (Preparation of Resin Compositions A4 to A8)

As in the procedure of Synthetic Example 1, to 100 parts by mass of a thermoplastic polyester elastomer (VYLON GM400: Toyobo Co., Ltd.), 3, 5, 7, 10, and 12 parts by mass of CARBODILITE LA1 (Nisshinbo Chemical Inc.) was added to prepare five resin compositions A4 to A8. The melt flow rate (MFR) of each resin composition obtained was measured according to JIS K7210. The amounts of CARBODILITE LA1 added and the MFR values of the resin compositions are shown in Table 4.

### Examples 4 to 8

As in Example 1, adhesive layers were prepared by using the resin composition A4 to A8 to form reinforcing tapes.

### <Adhesive Force to PPS>

As in Example 1, the reinforcing tape was bonded to a PPS film so as to prepare a sample for evaluating adhesion to the PPS. This evaluation sample was placed in an environment at a temperature of 85° C. and a humidity of 85%, and peel strength immediately after and 1,000 hours after the bonding of the reinforcing tape was measured at three points, and the average thereof was use to evaluate adhesive force.

### <Conductor Adhesive Force>

A nickel-plated rectangular conductor having a width of 0.3 mm and a thickness of 0.035 mm was placed on the reinforcing tape, and bonded to the reinforcing tape by conducting heat pressing at a reinforcing-tape-side temperature of 215° C. and a conductor-side temperature of 110° C. for a pressing time of 2 seconds at a pressure of 0.3 MPa. The 180° peel strength of one core of the conductor was determined and assumed to be the conductor adhesive force. Measurement of MFR and evaluation of the conductor adhesive force were conducted for Examples 1 to 3 and Comparative Example 4 also. The results are summarized in Table 4.

TABLE 4

| | | | | | | | | | Comparative |
|---|---|---|---|---|---|---|---|---|---|
| | Example 1 | Example 2 | Example 3 | Example 4 | Example 5 | Example 6 | Example 7 | Example 8 | Example 4 |
| Resin composition | A1 | A2 | A3 | A4 | A5 | A6 | A7 | A8 | CA4 |
| CARBODILITE LA1 | 0.5 | 1 | 2 | 3 | 5 | 7 | 10 | 12 | 0 |
| Amount added (parts | | | | | | | | | |
| by mass) | | | | | | | | | |
| MFR: 190°, 2.16 kg | 10.0 | 7.0 | 5.0 | 4.5 | 4.0 | 2.5 | 1.0 | Undetectable | 16.0 |
| (g/10 min) | | | | | | | | | |
| Adhesion strength to | 29.0 | 29.0 | 56.0 | 55.0 | 57.0 | 55.5 | 56.2 | 55.3 | 17.0 |
| PPS | | | | | | | | | |
| Immediately after | | | | | | | | | |
| bonding (N/10 mm) | | | | | | | | | |
| Adhesion strength to | 7.5 | 20.6 | 51.2 | 53.0 | 52.0 | 52.5 | 53.4 | 53.0 | 2.0 |
| PPS | | | | | | | | | |
| 1,000 hours after | | | | | | | | | |
| bonding (N/10 mm) | | | | | | | | | |
| Conductor adhesion | 0.15 | 0.25 | 0.30 | 0.35 | 0.45 | 0.5 | 0.55 | 0.55 | 0.10 |
| strength | | | | | | | | | |
| Immediately after | | | | | | | | | |
| bonding (N/core) | | | | | | | | | |
| Conductor adhesion | 0.15 | 0.30 | 0.40 | 0.40 | 0.50 | 0.55 | 0.60 | 0.60 | 0.01 |
| strength | | | | | | | | | |
| 1,000 hours after | | | | | | | | | |
| bonding (N/core) | | | | | | | | | |

Increasing the amount of CARBODILITE added improved adhesive force in all examples. As for the adhesive force to PPS, adding 2 parts by mass of CARBODILITE achieved the adhesive force that causes the PPS film to break but the adhesive force did not change beyond that amount and saturated. The conductor adhesive force was also improved by increasing the amount of CARBODILITE added, but the adhesive force substantially saturated at 5 parts by mass or more. Increasing the amount of CARBODILITE added caused the reaction with the base resin to proceed, and thus decreased MFR and degraded workability. In Example 8 in which 12 parts by mass of CARBODILITE was added, the MFR could not be determined. These results show that, from the viewpoints of adhesive force and workability, the amount of CARBODILITE added is preferably 0.5 parts by mass or more and 10 parts by mass or less, and more preferably 2 parts by mass or more and 7 parts by mass or less.

### INDUSTRIAL APPLICABILITY

According to the present invention, a reinforcing tape for a flat cable that can maintain sufficient adhesive force for a long time in a high-temperature, high-humidity environment, and a flat cable that uses this reinforcing tape for a flat cable can be provided.

### REFERENCE SIGNS LIST

1 reinforcing tape
2 base layer
3 adhesive layer
4 flat cable
5 coating material
6 conductor
6a end portion of conductor
7 cable body
A exposed region

1: A reinforcing tape for a flat cable, comprising a base layer containing a resin as a main component, and an adhesive layer stacked on one side of the base layer,
wherein the adhesive layer contains a thermoplastic resin and a polycarbodiimide compound,
the polycarbodiimide compound contains an isocyanate group, and
wherein the polycarbodiimide compound further contains an alicyclic structure.

2: The reinforcing tape for a flat cable according to claim 1, wherein a content of the polycarbodiimide compound relative to 100 parts by mass of the thermoplastic resin is 0.5 parts by mass or more and 10 parts by mass or less.

3. (canceled)

4: The reinforcing tape for a flat cable according to claim 1, wherein the thermoplastic resin is a thermoplastic polyester.

5: The reinforcing tape for a flat cable according to claim 1, wherein the main component of the base layer is polyethylene terephthalate.

6: A flat cable comprising at least one conductor and a pair of coating materials sandwiching the at least one conductor,
wherein the flat cable has a region where the at least one conductor is exposed, the region being located in an end portion in a longitudinal direction, and
the flat cable further comprises the reinforcing tape for a flat cable according to claim 1, the reinforcing tape being stacked so that the adhesive layer is bonded to one side of the exposed region.

7: The flat cable according to claim 6, wherein a main component of an outermost layer of each of the coating materials is polyphenylene sulfide.
